(19) United States
(12) Patent Application Publication
(10) Pub. No.: US 2026/0268675 A1
(43) Pub. Date: Sep. 10, 2026

(54) OBJECT DETECTION METHOD AND SYSTEM BASED ON SYNCHRONIZED VIDEO FRAME READING, AND DEVICE

(71) Applicant: CHONGQING UNIVERSITY OF ARTS AND SCIENCES, Chongqing (CN)

(72) Inventors: Xinqiang MA, Chongqing (CN); Yi HUANG, Chongqing (CN); Wang LI, Chongqing (CN); Qiang LI, Chongqing (CN); Zhongjie WAN, Chongqing (CN); Youyuan LIU, Chongqing (CN); Jinsheng BAI, Chongqing (CN); Shuang ZHENG, Chongqing (CN); Kainan XIONG, Chongqing (CN); Junde ZHANG, Chongqing (CN); Yang KANG, Chongqing (CN); Zhigang YANG, Chongqing (CN); Quangui ZHANG, Chongqing (CN); Guoxin ZHANG, Chongqing (CN); Wenjun ZHANG, Chongqing (CN)

(21) Appl. No.: 19/164,534

(22) PCT Filed: Apr. 7, 2024
(86) PCT No.: PCT/CN2024/086345

§ 371 Date: Sep. 11, 2025

(30) Foreign Application Priority Data
Oct. 23, 2023 (CN) 202311374159.5

(51) Int. Cl. G06V 20/52; G06V 20/70; H04N 21/43; H04N 21/8547

(52) U.S. Cl. CPC G06V 20/52; G06V 20/70; H04N 21/43076; H04N 21/8547; G06V 2201/07

(57) ABSTRACT

Provided are an object detection method and system based on synchronized video frame reading, and a device, and relate to the field of data extraction technologies for object detection. The method is applied to a monitoring system, and includes: determining, according to a plurality of low-latency buffer queues, a synchronized timestamped video sequence, where a timestamp difference corresponding to any two timestamped video frames in the synchronized timestamped video sequence is less than a timestamp difference threshold; and inputting the synchronized timestamped video sequence into an object detection model to obtain an object detection result corresponding to a central timestamp. A camera device is configured with a network time protocol (NTP) client, a reading thread, and an FFmpeg encoding thread to obtain the synchronized timestamped video sequence, and the object detection module is trained to improve precision of identifying monitoring anomaly.

### CROSS REFERENCE TO RELATED APPLICATION

This patent application is a national stage application of International Patent Application No. PCT/CN2024/086345, filed on Apr. 7, 2024, which claims the benefit and priority of Chinese Patent Application No. 202311374159.5, filed with the China National Intellectual Property Administration on Oct. 23, 2023, the disclosure of which is incorporated by reference herein in its entirety as part of the present application.

### TECHNICAL FIELD

The present disclosure relates to the field of data extraction technologies for object detection, and in particular, relates to an object detection method and system based on synchronized video frame reading, and a device.

### BACKGROUND

With continuous improvement of industrial automation, video surveillance technologies and intelligent algorithm-based detection have been widely applied across various stages of industrial production, such as production line quality detection and operation process monitoring. In addition, an industrial environment imposes stringent real-time performance and accuracy requirements on video surveillance technologies and intelligent algorithms. However, achieving these objectives is significantly complicated by challenging production conditions and operational complexities. During surveillance in a production process, it is difficult for a conventional single-camera monitoring method to comprehensively monitor details of procedures of the entire production line due to limitation of capturing information under monocular vision, easily leading to missed identification of some critical defects. Furthermore, transient shielding caused by equipment or personnel cannot be reliably identified under monocular vision, significantly compromising monitoring integrity.

### SUMMARY

An objective of the present disclosure is to provide an object detection method and system based on synchronized video frame reading, and a device, to improve precision of identifying monitoring abnormality.

To achieve the above objective, the present disclosure provides the following technical solutions.

An object detection method based on synchronized video frame reading is provided, where the object detection method is applied to a monitoring system, the monitoring system includes a network time protocol (NTP) server and a plurality of camera devices; the NTP server and the plurality of camera devices are all disposed in a same local area network; and any one of the camera devices is configured with an NTP client, a reading thread, and an FFmpeg encoding thread;
the NTP client is configured to generate a timestamp while a video frame is generated by a corresponding camera device;
the NTP server is configured to synchronize timestamps generated by a plurality of NTP clients at a same moment;
the reading thread is configured to read raw video stream data of a plurality of video frames generated by the corresponding camera device and a timestamp corresponding to each video frame; and
the FFmpeg encoding thread is configured to encode, according to a time sequence, the raw video stream data of each video frame and the timestamp corresponding to each video frame to obtain a plurality of timestamped video frames, so as to form a low-latency buffer queue of the corresponding camera device; and
the object detection method includes:
determining, according to a plurality of low-latency buffer queues, a synchronized timestamped video sequence, where a timestamp difference corresponding to any two timestamped video frames in the synchronized timestamped video sequence is less than a timestamp difference threshold; and
inputting the synchronized timestamped video sequence into an object detection model to obtain an object detection result corresponding to a central timestamp, where the object detection model is obtained by training a deep learning model by using a plurality of annotated synchronized timestamped video historical sequences.

Optionally, the determining, according to the plurality of low-latency buffer queues, a synchronized timestamped video sequence includes:
sequentially extracting, according to a serial number of the corresponding camera device, one timestamped video frame from each low-latency buffer queue, to obtain a synchronized timestamped video pending sequence;
determining whether a timestamp difference corresponding to two timestamped video frames in the synchronized timestamped video pending sequence is less than the timestamp difference threshold, to obtain a first determining result;
if the first determining result is yes, updating the plurality of low-latency buffer queues, and returning to the step of “sequentially extracting, according to a serial number of the corresponding camera device, one timestamped video frame from each low-latency buffer queue, to obtain a synchronized timestamped video pending sequence”; and
if the first determining result is no, determining the synchronized timestamped video pending sequence as the synchronized timestamped video sequence.

Optionally, the updating the plurality of low-latency buffer queues includes:
determining a timestamp mean value corresponding to the synchronized timestamped video pending sequence;
determining two timestamped video frames whose timestamp difference is greater than the timestamp difference threshold as pending video frames;
determining a pending video frame whose timestamp has a maximum difference with the timestamp mean value as a reference video frame;
determining whether a timestamp corresponding to the reference video frame is earlier than the timestamp mean value, to obtain a second determining result;
if the second determining result is yes, deleting the reference video frame from a low-latency buffer queue corresponding to the reference video frame;
if the second determining result is no, determining a timestamped video frame other than the reference video frame in the synchronized timestamped video pending sequence as a non-reference video frame; and
deleting a corresponding non-reference video frame from a low-latency buffer queue corresponding to each non-reference video frame.

Optionally, before determining, according to the plurality of low-latency buffer queues, a synchronized timestamped video sequence, the method further includes:
obtaining a plurality of low-latency buffer historical queues;
determining, according to the plurality of low-latency buffer historical queues, a synchronized timestamped video historical sequence;
respectively annotating objects in the synchronized timestamped video historical sequence to obtain an annotated synchronized timestamped video historical sequence; and
training the deep learning model by using the annotated synchronized timestamped video historical sequence as an input, and using an object annotation result as an output, to obtain the object detection model.

An object detection system based on synchronized video frame reading is provided, including:
a synchronized timestamped video sequence obtaining module, configured to determine, according to a plurality of low-latency buffer queues, a synchronized timestamped video sequence, where a timestamp difference corresponding to any two timestamped video frames in the synchronized timestamped video sequence is less than a timestamp difference threshold; and
an object detection module, configured to input the synchronized timestamped video sequence into an object detection model to obtain an object detection result corresponding to a central timestamp, where the object detection model is obtained by training a deep learning model by using a plurality of annotated synchronized timestamped video historical sequences.

An electronic device is provided, including a memory and a processor, where the memory is configured to store a computer program, and the processor runs the computer program to enable the electronic device to execute the foregoing object detection method based on synchronized video frame reading.

Optionally, the memory is a readable storage medium.

According to specific embodiments provided in the present disclosure, the present disclosure has the following technical effects:

The object detection method and system based on synchronized video frame reading, and the device are provided in the present disclosure, and are applied to a monitoring system. A synchronized timestamped video sequence is determined according to a plurality of low-latency buffer queues, where a timestamp difference corresponding to any two timestamped video frames in the synchronized timestamped video sequence is less than a timestamp difference threshold. The synchronized timestamped video sequence is input into the object detection module to obtain an object detection result corresponding to a central timestamp. According to the present disclosure, the camera device is configured with a NTP client, a reading thread, and an FFmpeg encoding thread to obtain the synchronized timestamped video sequence, and the object detection module is trained to improve precision of identifying monitoring anomaly.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of an object detection method based on synchronized video frame reading in Embodiment 1 of the present disclosure;

FIG. 2 is a schematic diagram of a principle of an object detection method based on synchronized video frame reading in Embodiment 1 of the present disclosure;

FIG. 3 is a schematic diagram of a network time protocol (NTP) architecture of an object detection method in Embodiment 1 of the present disclosure;

FIG. 4 is a flowchart of obtaining a video frame in Embodiment 1 of the present disclosure;

FIG. 5 is a flowchart of video frame encoding in Embodiment 1 of the present disclosure;

FIG. 6 is a flowchart of video frame synchronization in Embodiment 1 of the present disclosure;

FIG. 7 is a flowchart of video frame synchronization inference in Embodiment 1 of the present disclosure; and

FIG. 8 is a schematic diagram of a structure of a terminal device in Embodiment 1 of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other examples obtained by a person of ordinary skill in the art based on the embodiments of the present disclosure without creative efforts shall fall within the protection scope of the present disclosure.

An objective of the present disclosure is to provide an object detection method and system based on synchronized video frame reading, and a device, to improve precision of identifying monitoring abnormality.

In order to make the above objective, features and advantages of the present disclosure clearer and more comprehensible, the present disclosure will be further described in detail below in combination with accompanying drawings and particular implementations.

### Embodiment 1

This embodiment provides an object detection method based on synchronized video frame reading. The object detection method is applied to a monitoring system, and the monitoring system comprises a network time protocol (NTP) server and a plurality of camera devices. The NTP server and the plurality of camera devices are all disposed in a same local area network. Any one of the camera devices is configured with an NTP client, a reading thread, and an FFmpeg encoding thread. The NTP client is configured to generate a timestamp while a video frame is generated by a corresponding camera device. The NTP server is configured to synchronize timestamps generated by a plurality of NTP clients at a same moment. The reading thread is configured to read raw video stream data of a plurality of video frames generated by the corresponding camera device and a timestamp corresponding to each video frame. The FFmpeg encoding thread is configured to encode, according to a time sequence, the raw video stream data of each video frame and the timestamp corresponding to each video frame to obtain a plurality of timestamped video frames, so as to form a low-latency buffer queue of the corresponding camera device.

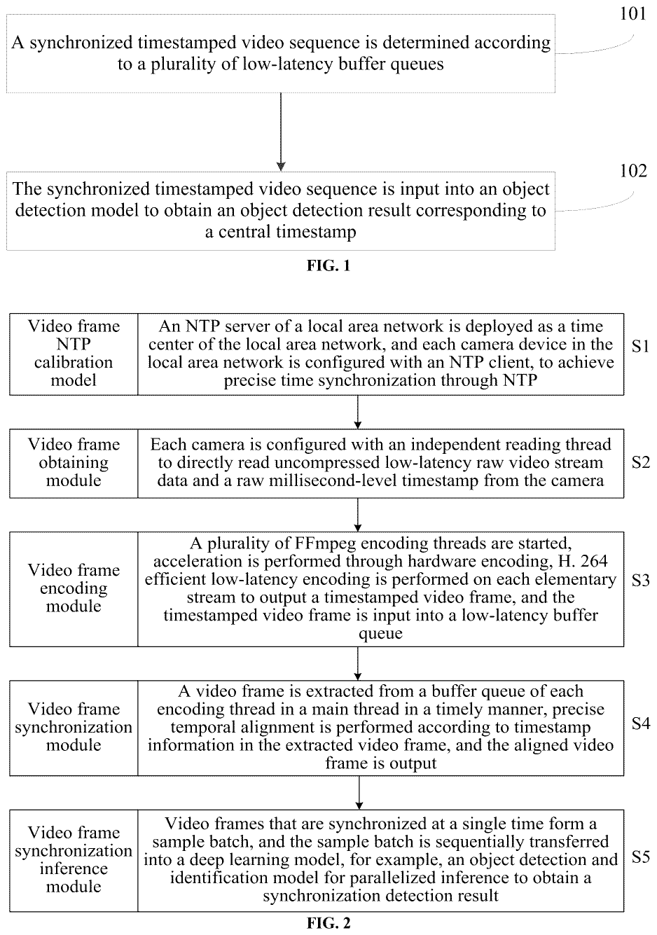

As shown in FIG. 1 and FIG. 2, the object detection method includes the following steps.

In step 101, a synchronized timestamped video sequence is determined according to a plurality of low-latency buffer queues. A timestamp difference corresponding to any two timestamped video frames in the synchronized timestamped video sequence is less than a timestamp difference threshold.

In step 102, the synchronized timestamped video sequence is input into an object detection model to obtain an object detection result corresponding to a central timestamp. The object detection model is obtained by training a deep learning model by using a plurality of annotated synchronized timestamped video historical sequences.

Step 101 includes the following steps.

In step 101-1, one timestamped video frame is sequentially extracted, according to a serial number of the corresponding camera device, from each low-latency buffer queue, to obtain a synchronized timestamped video pending sequence.

In step 101-2, whether a timestamp difference corresponding to two timestamped video frames in the synchronized timestamped video pending sequence is less than the timestamp difference threshold is determined to obtain a first determining result. If the first determining result is yes, step 101-3 is performed; and if the first determining result is no, step 101-4 is performed.

In step 101-3, the plurality of low-latency buffer queues are updated, and step 101-1 is returned.

In step 101-4, the synchronized timestamped video pending sequence is determined as the synchronized timestamped video sequence.

Step 101-3 includes the following steps.

In step 101-3-1, a timestamp mean value corresponding to the synchronized timestamped video pending sequence is determined.

In step 101-3-2, two timestamped video frames whose timestamp difference is greater than the timestamp difference threshold are determined as pending video frames.

In step 101-3-3, a pending video frame whose timestamp has a maximum difference with the timestamp mean value is determined as a reference video frame.

In step 101-3-4, whether a timestamp corresponding to the reference video frame is earlier than the timestamp mean value is determined, to obtain a second determining result. If the second determining result is yes, step 101-3-5 is performed; and if the second determining result is no, step 101-3-6 is performed.

In step 101-3-5, a corresponding non-reference video frame is deleted from a low-latency buffer queue corresponding to the reference video frame.

In step 101-3-6, a timestamped video frame other than the reference video frame in the synchronized timestamped video pending sequence is determined as a non-reference video frame.

In step 101-3-7, a corresponding non-reference video frame is deleted from a low-latency buffer queue corresponding to each non-reference video frame.

Before step 101, the method further includes the following steps:

In step 103, a plurality of low-latency buffer historical queues are obtained.

In step 104, a synchronized timestamped video historical sequence is determined according to the plurality of low-latency buffer historical queues.

In step 105, objects in the synchronized timestamped video historical sequence are respectively annotated to obtain an annotated synchronized timestamped video historical sequence.

In step 106, the deep learning model is trained by using the annotated synchronized timestamped video historical sequence as an input, and using an object annotation result as an output, to obtain the object detection model.

Specifically, the present disclosure provides an object detection method based on synchronized video frame reading, including the following steps.

In step S1, in a network time protocol (NTP) calibration module, a NTP server of a local area network is deployed as a time center of the local area network, and each camera device in the local area network is configured with an NTP client, to achieve precise NTP time synchronization. This step is implemented by the NTP calibration module.

In step S2, each camera is configured with an independent reading thread to directly read uncompressed low-latency raw video stream data and a raw millisecond-level timestamp from the camera. This step is implemented by a video frame obtaining module.

In step S3, a plurality of FFmpeg encoding threads are started, acceleration is performed through hardware encoding. H. 264 efficient low-latency encoding is performed on each elementary stream to output a timestamped video frame, and the timestamped video frame is input into a low-latency buffer queue. This step is implemented by a video frame encoding module.

In step S4, a video frame is extracted from a buffer queue of each encoding thread in a main thread in a timely manner, precise temporal alignment is performed according to timestamp information in the extracted video frame, and the aligned video frame is output. The aligned video frame is a synchronized video frame whose timestamp is within a deviation range. This step is implemented by a video frame synchronization module.

In step S5, video frames that are synchronized at a single time form a sample batch, and the sample batch is sequentially transferred into a deep learning model, for example, an object detection and identification model for parallelized inference to obtain a synchronized detection result. This step is implemented by a video frame synchronization inference module.

Step S1 specifically includes the following steps.

In the local area network, a computer with strong performance needs to be selected as the network time protocol (NTP) server. The server serves as a time source to provide accurate time information. NTP server software is installed and configured, so that a time synchronization service can be provided by the server to another device.

Then, a camera device on which time synchronization needs to be performed is configured. In an operating system of each camera device, the NTP client is configured. Being configured with the NTP client, the camera device can be connected to the NTP server for scheduled time synchronization and calibration. In this way, accurate time information can be obtained by the camera device from the NTP server, and system time of the camera device can be updated and calibrated.

Through NTP time synchronization, millisecond-level time synchronization precision can be kept between all camera devices in the local area network and a clock of the NTP server. This means that the system time of the camera device can be highly consistent with the clock of the NTP server for synchronization with millisecond-level precision. Based on this time synchronization precision, a timestamp is consistent when video data is recorded and processed by the camera device, thereby providing accurate time reference for subsequent data analysis and processing.

The NTP is a protocol specifically designed for time synchronization in a computer network. The objective of the NTP is to coordinate clocks of device nodes in the network, ensuring a unified time reference while providing high-precision time calibration with a millisecond-level or a higher level.

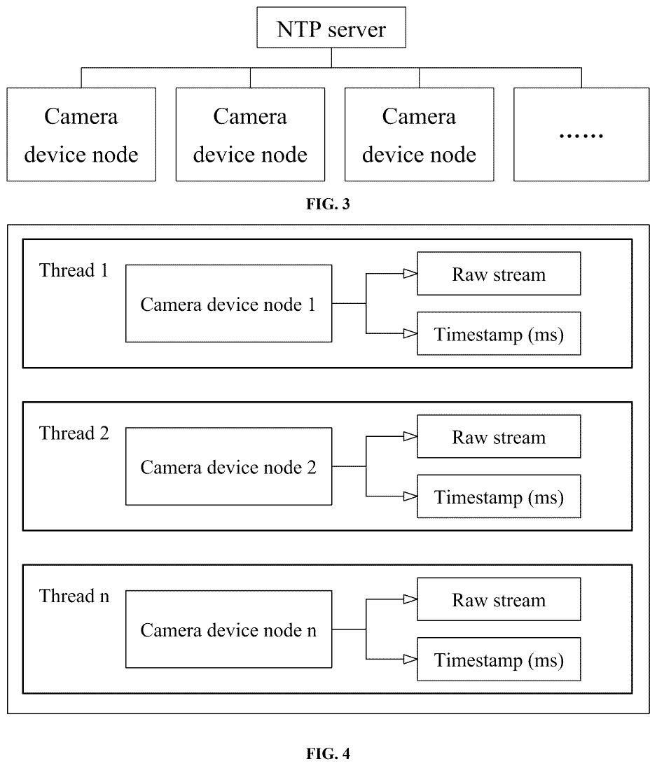

As shown in FIG. 3, a computer device that is continuously operated for 24 hours is disposed in the local area network as the NTP server, and a related camera is connected to the current local area network and is configured with a NTP client, to ensure that precise time reference is provided for all camera devices connected to the NTP server.

Step S2 specifically includes the following steps.

To avoid an additional encoding/decoding latency caused by a video compression algorithm and obtain uncompressed high-quality low-latency raw stream data and a millisecond-level timestamp, a separate thread is created for each camera that requires video frame reading.

Each thread is dedicated to reading raw stream data from a corresponding camera and obtaining an accurate millisecond-level timestamp by using a NTP service. In this way, an additional encoding/decoding latency is avoided, and high-quality video data with an extremely low latency is obtained for subsequent use.

A raw video stream is collected or obtained raw video data that is not compressed or encoded. Complete information of a video signal is kept in an elementary stream. The complete information includes an exact value and color information of each pixel, and timestamp information associated with a video frame.

The timestamp is a numerical value, and is used to precisely record event occurrence time. In the video processing field, the timestamp is used to mark an exact moment for obtaining a video frame. For each video frame, the timestamp indicates exact time for capturing or obtaining the video frame. The timestamp is usually indicated in a special time unit (for example, millisecond), to indicate amount of time elapsed since a reference timepoint (for example, a video playback start timepoint or a system boot timepoint).

As shown in FIG. 4, each camera requiring video frame obtaining is assigned to a dedicated thread, enabling parallel processing and reading operations without mutual interference. In addition, video frame data is ensured by the accurate timestamp provided by using the NTP service to have a high-quality millisecond-level timestamp mark. This facilitates subsequent video processing and analysis.

Step S3 specifically includes the following steps.

An independent FFmpeg thread is used to encode each video steam, to perform H.264 encoding on each obtained elementary stream. Efficiency and performance in an encoding process can be improved by using an applicable hardware encoding acceleration technology. Once the video frame is encoded, the encoded video frame and a corresponding timestamp are stored in a buffer queue.

FFmpeg is a cross-platform and open-source multimedia processing toolkit, including extensive audio and video processing tools and libraries. FFmpeg has a capability of processing various audio/video formats, and provides rich functions and libraries for multimedia processing tasks including, but not limited to: decoding, encoding, transcoding, clipping, merging, and streaming transmission.

H.264 encoding is a general and extensive video compression standard and encoding format. H.264 encoding is used to effectively compress video data and reduce a bit rate, achieving high-quality video transmission and storage.

Hardware encoding is a process in which a video is compressed and encoded via a dedicated hardware encoder. The hardware encoder is a dedicated hardware device that integrates a highly-optimized encoding algorithm and a highly-optimized circuit design, and can be configured to achieve quick and efficient video encoding.

The hardware encoder is an embedded hardware module, is usually integrated into a central processing unit (CPU), a graphics processing unit (GPU), or a dedicated encoder chip, has a highly optimized algorithm and a parallel processing capability, and can be configured to complete video encoding more efficiently, thereby providing a quick and efficient video encoding function.

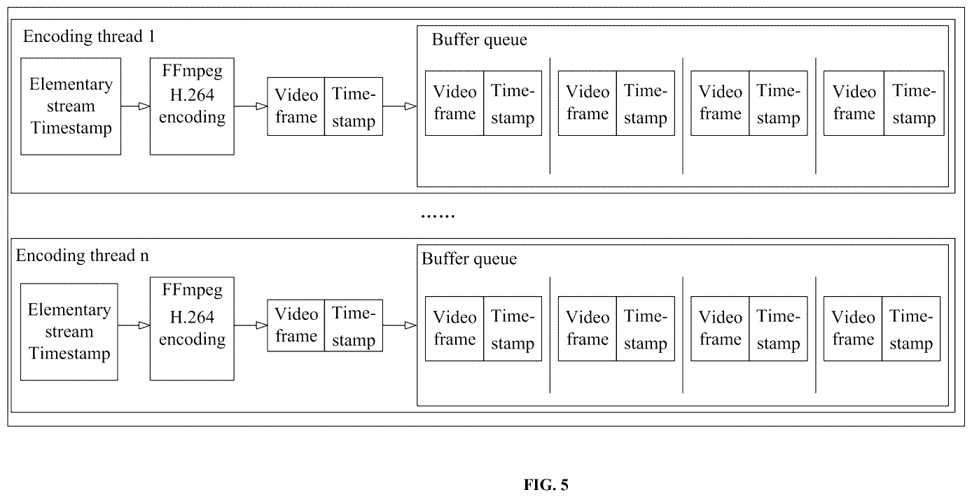

As shown in FIG. 5, a dedicated FFmpeg thread is set for each video stream for H.264 encoding. A plurality of video steams can be processed in parallel by using an independent thread, and therefore, overall encoding efficiency is improved.

In an encoding process, an appropriate hardware encoding technology can be used to improve performance. An encoding algorithm is accelerated by using the technology via a dedicated hardware (for example, the GPU), thereby reducing encoding time and resource consumption. Hardware resources are sufficiently utilized, to achieve a more efficient encoding process.

Once the video frame is encoded, the encoded video frame and a corresponding timestamp are stored in a buffer queue. The buffer queue is used to store a to-be-processed video frame, for subsequent processing or transmission. Encoded video data can be effectively managed by using the buffer queue, and a correspondence between the timestamp and the video frame is ensured to be not lost or corrupted.

Step S4 specifically includes the following steps.

In the main thread, a plurality of encoded camera video frames and corresponding timestamps are obtained, according to a sequence, from the buffer queue. Then, the timestamps are compared, and an absolute value of a time difference between the timestamps is calculated, to obtain a time derivation value. An appropriate timestamp derivation range is set to determine whether the time derivation value is within the set derivation range, and then whether a current video frame is a synchronized video frame is determined. In other words, whether the current video frame and the synchronized video frame have consistent time marks are determined.

The timestamp derivation range is a time value in millisecond, and is used to determine synchronization of video frames. Specifically, if a time difference calculated based on timestamps of the plurality of videos is less than or equal to the set timestamp deviation range, it may be determined that the video frames are synchronized.

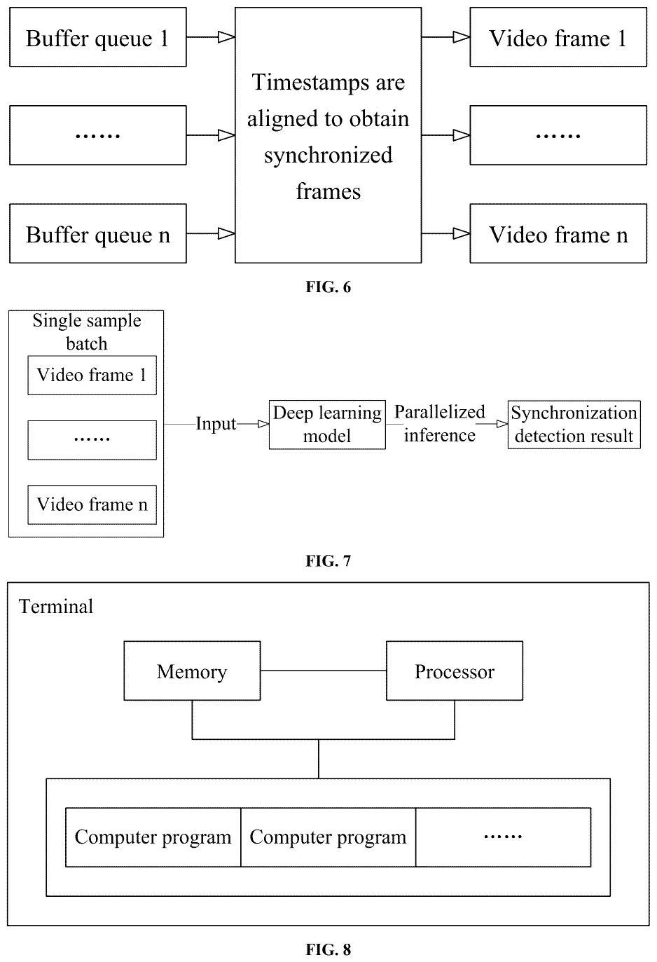

As shown in FIG. 6, in the main thread, video frames and corresponding timestamps are extracted, according to a sequence of the video frames, from the buffer queue one by one, and capturing or encoding time of the video frames is recorded in the timestamps. The timestamps are compared to calculate an absolute time of a time difference between the video frames, namely, a time derivation. A time deviation value reflects a time relationship of the video frames.

A millisecond-level time derivation range needs to be set, to determine whether a video frame is synchronized. If the time derivation value falls within the set range, it may be considered that the current video frame has a consistent time mark, in other words, the current video frame is kept synchronized with another video frame. Time synchronization determining may help keeping video frames of a plurality of cameras consistent in a playing or processing process, to determine whether the video frames are synchronized video frames.

Step S5 specifically includes the following steps.

After the synchronized video frames are temporally aligned, video frames of a same batch are combined into a sample batch. The sample batch may include the video frames of the plurality of cameras. The video frames are in a scenario captured at a same moment.

The sample batch may be transmitted to the deep learning model, for example, the object detection model, for parallelized inference. Each video frame in the sample batch is processed by the deep learning model, to identify and detect an object in the video frame. The video frames are captured at a same moment, and are temporally aligned, and therefore, parallelized inference can be performed by the deep learning model on the video frames. In this way, an object identification result can be obtained at a same moment from the plurality of camera video frames.

As shown in FIG. 7, the temporally-aligned synchronized video frames form a sample batch, and the sample batch is input into the deep learning model, for example, the object detection model, for parallelized inference. The video frames are processed at a same time, and an object identification result can be obtained by the model from the plurality of the cameras at a same moment. The video frames are captured at a same moment. Therefore, the model can be configured to perform effective information sharing and context understanding between the video frames. In this way, efficiency and performance of the model are improved, inference time is shortened, and more accurate object detection can be performed by the model through temporal alignment.

According to the present disclosure, the NTP server is locally disposed to implement a time synchronization calibration service for each camera in the local area network. The video frame obtaining module is configured to dispose an independent thread for each camera to obtain a raw stream and a millisecond-level timestamp. The video frame encoding module is configured to efficiently encode raw stream data through a video encoding tool. The video frame synchronization inference module is configured to perform parallelized inference by inputting a batch including video frames that are synchronized for a single time to the deep learning model. In this way, more efficient and accurate video content understanding and detection identification can be achieved, and accuracy and reliability of a video inference task based on a video can be effectively improved.

### Embodiment 2

To implement the method corresponding to Embodiment 1 and achieve corresponding functions and technical effects, the following provides an object detection system based on synchronized video frame reading, including: a synchronized timestamped video sequence obtaining module, and an object detection module.

The synchronized timestamped video sequence obtaining module is configured to determine a synchronized timestamped video sequence according to a plurality of low-latency buffer queues. A timestamp difference corresponding to any two timestamped video frames in the synchronized timestamped video sequence is less than a timestamp difference threshold.

The object detection module is configured to input the synchronized timestamped video sequence into an object detection model to obtain an object detection result corresponding to a central timestamp. The object detection model is obtained by training a deep learning model by using a plurality of annotated synchronized timestamped video historical sequences.

### Embodiment 3

This embodiment provides an electronic device, including a memory and a processor, where the memory is configured to store a computer program, and the processor runs the computer program to enable the electronic device to perform object detection method based on synchronized video frame reading in Embodiment 1. The memory is a readable storage medium. As shown in FIG. 8, the electronic device in this embodiment includes a processor, a memory, and a computer program stored in the memory and able to run on the processor, for example, a real-time video synchronization reading program and a synchronization inference program. When the processor executes the computer program, the processor implements the steps in the above-mentioned method embodiments of real-time video synchronization reading and synchronization inference detection, for example, steps S1 to S5 shown in FIG. 1. Alternatively, the processor executes the computer program to implement functions of the modules in the above-mentioned apparatus embodiments.

For example, the computer program may be divided into one or more modules/units. The one or more modules/units are stored in the memory and executed by the processor to complete the present disclosure. The one or more modules/units may be a series of computer program instruction segments capable of implementing specific functions, and the instruction segments are used for describing an execution process of the computer program in the terminal device. For example, the computer program may be divided into modules. For specific functions of the modules, details are not described herein again.

The terminal device may be a computing device, for example, a desktop computer, a notebook, a palmtop computer, or a cloud server. The terminal device may include, but not limited to, a processor and a memory. Those skilled in the art can understand that the schematic diagram shows only an example of the terminal device, does not constitute a limitation to the terminal device, and may include more or less components than that shown in the figure, a combination of some components, or different components. For example, the terminal device may also include input and output devices, network access devices, buses, and the like.

The processor may be a central processing unit (CPU), or may be another general-purpose processor, another programmable logic device, a discrete gate or transistor logic device, a discrete hardware component, or the like. The general-purpose processor may be a microprocessor, or any conventional processor. The processor is a control center of the terminal device, and various parts of the whole terminal device are connected by using various interfaces and lines.

The memory may be configured to store the computer program and/or modules. The processor implements various functions of the terminal device by running or executing the computer program and/or modules stored in the memory and invoking data stored in the memory. The memory may mainly include a program storage area and a data storage area. The program storage area may store an operating system, an application program required by at least one function (for example, a sound playing function and an image playing function), and the like. The data storage area may store data (such as audio and video data, and a file) created based on use of a computer, and the like. In addition, the memory may include a high-speed random access memory, and may further include a nonvolatile memory, for example, a hard disk drive, a memory, hot-swappable drive, a flash memory card, at least one magnetic disk storage device, a flash storage device, or another nonvolatile solid-state storage device.

The module or unit integrated in the terminal device, if implemented in a form of a software functional unit and sold or used as a stand-alone product, may be stored in a computer-readable storage medium. Based on such an understanding, all or some of processes for implementing the methods in the foregoing embodiments can be completed by a computer program instructing relevant hardware. The computer program may be stored in a computer-readable storage medium. The computer program is executed by a processor to perform the steps of the foregoing method embodiments. The computer program includes computer program code, and the computer program code may be in a form of source code, a form of object code, an executable file or some intermediate forms, and the like. The computer-readable medium may include: any physical entity or apparatus capable of carrying computer program code, a recording medium, a USB disk, a mobile hard disk drive, a magnetic disk, an optical disc, a computer memory, a read-only memory (ROM), a random access memory (RAM), an electrical carrier signal, a telecommunications signal, a software distribution medium, and the like.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, reference can be made to the description of the method.

Particular examples are used herein for illustration of principles and implementations of the present disclosure. The descriptions of the above embodiments are merely used for assisting in understanding the method of the present disclosure and its core ideas. In addition, a person of ordinary skill in the art can make various modifications in terms of particular implementations and an application scope in accordance with the ideas of the present disclosure. In conclusion, the content of the description shall not be construed as limitations to the present disclosure.

1. An object detection method based on synchronized video frame reading, wherein the object detection method is applied to a monitoring system, and the monitoring system comprises a network time protocol (NTP) server and a plurality of camera devices; the NTP server and the plurality of camera devices are all disposed in a same local area network; and any one of the camera devices is configured with an NTP client, a reading thread, and an FFmpeg encoding thread;
the NTP client is configured to generate a timestamp while a video frame is generated by a corresponding camera device;
the NTP server is configured to synchronize timestamps generated by a plurality of NTP clients at a same moment;
the reading thread is configured to read raw video stream data of a plurality of video frames generated by the corresponding camera device and a timestamp corresponding to each video frame; and
the FFmpeg encoding thread is configured to encode, according to a time sequence, the raw video stream data of each video frame and the timestamp corresponding to each video frame to obtain a plurality of timestamped video frames, so as to form a low-latency buffer queue of the corresponding camera device; and
the object detection method comprises:
determining, according to a plurality of low-latency buffer queues, a synchronized timestamped video sequence, wherein a timestamp difference corresponding to any two timestamped video frames in the synchronized timestamped video sequence is less than a timestamp difference threshold; and
inputting the synchronized timestamped video sequence into an object detection model to obtain an object detection result corresponding to a central timestamp, wherein the object detection model is obtained by training a deep learning model by using a plurality of annotated synchronized timestamped video historical sequences.

2. The object detection method based on synchronized video frame reading according to claim 1, wherein the determining, according to a plurality of low-latency buffer queues, a synchronized timestamped video sequence comprises:
sequentially extracting, according to a serial number of the corresponding camera device, one timestamped video frame from each low-latency buffer queue, to obtain a synchronized timestamped video pending sequence;
determining whether a timestamp difference corresponding to two timestamped video frames in the synchronized timestamped video pending sequence is less than the timestamp difference threshold, to obtain a first determining result;
if the first determining result is yes, updating the plurality of low-latency buffer queues, and returning to the step of “sequentially extracting, according to a serial number of the corresponding camera device, one timestamped video frame from each low-latency buffer queue, to obtain a synchronized timestamped video pending sequence”; and
if the first determining result is no, determining the synchronized timestamped video pending sequence as the synchronized timestamped video sequence.

3. The object detection method based on synchronized video frame reading according to claim 2, wherein the updating the plurality of low-latency buffer queues comprises:
determining a timestamp mean value corresponding to the synchronized timestamped video pending sequence;
determining two timestamped video frames whose timestamp difference is greater than the timestamp difference threshold as pending video frames;
determining a pending video frame whose timestamp has a maximum difference with the timestamp mean value as a reference video frame;
determining whether a timestamp corresponding to the reference video frame is earlier than the timestamp mean value, to obtain a second determining result;
if the second determining result is yes, deleting the reference video frame from a low-latency buffer queue corresponding to the reference video frame;
if the second determining result is no, determining a timestamped video frame other than the reference video frame in the synchronized timestamped video pending sequence as a non-reference video frame; and
deleting a corresponding non-reference video frame from a low-latency buffer queue corresponding to each non-reference video frame.

4. The object detection method based on synchronized video frame reading according to claim 1, wherein before the determining, according to a plurality of low-latency buffer queues, a synchronized timestamped video sequence, the method further comprises:
obtaining a plurality of low-latency buffer historical queues;
determining, according to the plurality of low-latency buffer historical queues, a synchronized timestamped video historical sequence;
respectively annotating objects in the synchronized timestamped video historical sequence to obtain an annotated synchronized timestamped video historical sequence; and
training the deep learning model by using the annotated synchronized timestamped video historical sequence as an input, and using an object annotation result as an output, to obtain the object detection model.

5. An object detection system based on synchronized video frame reading, comprising:
a synchronized timestamped video sequence obtaining module, configured to determine, according to a plurality of low-latency buffer queues, a synchronized timestamped video sequence, wherein a timestamp difference corresponding to any two timestamped video frames in the synchronized timestamped video sequence is less than a timestamp difference threshold; and
an object detection module, configured to input the synchronized timestamped video sequence into an object detection model to obtain an object detection result corresponding to a central timestamp, wherein the object detection model is obtained by training a deep learning model by using a plurality of annotated synchronized timestamped video historical sequences.

6. An electronic device, comprising: a memory and a processor, wherein the memory is configured to store a computer program, and the processor runs the computer program to enable the electronic device to perform the object detection method based on synchronized video frame reading according to claim 1.

7. The electronic device according to claim 6, wherein the memory is a readable storage medium.

8. The electronic device according to claim 6, wherein the determining, according to a plurality of low-latency buffer queues, a synchronized timestamped video sequence comprises:
sequentially extracting, according to a serial number of the corresponding camera device, one timestamped video frame from each low-latency buffer queue, to obtain a synchronized timestamped video pending sequence;
determining whether a timestamp difference corresponding to two timestamped video frames in the synchronized timestamped video pending sequence is less than the timestamp difference threshold, to obtain a first determining result;
if the first determining result is yes, updating the plurality of low-latency buffer queues, and returning to the step of “sequentially extracting, according to a serial number of the corresponding camera device, one timestamped video frame from each low-latency buffer queue, to obtain a synchronized timestamped video pending sequence”; and
if the first determining result is no, determining the synchronized timestamped video pending sequence as the synchronized timestamped video sequence.

9. The electronic device according to claim 7, wherein the updating the plurality of low-latency buffer queues comprises:
determining a timestamp mean value corresponding to the synchronized timestamped video pending sequence;
determining two timestamped video frames whose timestamp difference is greater than the timestamp difference threshold as pending video frames;
determining a pending video frame whose timestamp has a maximum difference with the timestamp mean value as a reference video frame;
determining whether a timestamp corresponding to the reference video frame is earlier than the timestamp mean value, to obtain a second determining result;
if the second determining result is yes, deleting the reference video frame from a low-latency buffer queue corresponding to the reference video frame;
if the second determining result is no, determining a timestamped video frame other than the reference video frame in the synchronized timestamped video pending sequence as a non-reference video frame; and
deleting a corresponding non-reference video frame from a low-latency buffer queue corresponding to each non-reference video frame.

10. The electronic device according to claim 6, wherein before the determining, according to a plurality of low-latency buffer queues, a synchronized timestamped video sequence, the method further comprises:
obtaining a plurality of low-latency buffer historical queues;
determining, according to the plurality of low-latency buffer historical queues, a synchronized timestamped video historical sequence;
respectively annotating objects in the synchronized timestamped video historical sequence to obtain an annotated synchronized timestamped video historical sequence; and
training the deep learning model by using the annotated synchronized timestamped video historical sequence as an input, and using an object annotation result as an output, to obtain the object detection model.

11. The electronic device according to claim 8, wherein the memory is a readable storage medium.

12. The electronic device according to claim 9, wherein the memory is a readable storage medium.

13. The electronic device according to claim 10, wherein the memory is a readable storage medium.
